(19) United States
(12) Patent Application Publication
(10) Pub. No.: US 2024/0127501 A1
(43) Pub. Date: Apr. 18, 2024

(54) X-RAY COMPUTED TOMOGRAPHY IMAGING APPARATUS, MEDICAL IMAGE CORRECTION METHOD, AND NONVOLATILE COMPUTER-READABLE STORAGE MEDIUM STORING MEDICAL IMAGE CORRECTION PROGRAM

(71) Applicant: CANON MEDICAL SYSTEMS CORPORATION, Otawara-shi (JP)

(72) Inventors: Masaharu TSUYUKI, Nasushiobara (JP); Yasutaka SHINDO, Nasushiobara (JP)

(73) Assignee: CANON MEDICAL SYSTEMS CORPORATION, Otawara-shi (JP)

(21) Appl. No.: 18/480,654

(22) Filed: Oct. 4, 2023

(30) Foreign Application Priority Data
Oct. 13, 2022 (JP) 2022-164738

(51) Int. Cl. G06T 11/00

(52) U.S. Cl. CPC G06T 11/008; G06T 2210/41; G06T 2211/408

(57) ABSTRACT

An X-ray computed tomography imaging apparatus according to one embodiment includes processing circuitry. The processing circuitry obtains reconstructed image data corresponding to a second energy range including an energy range different from a first energy range. The processing circuitry infers motion-quantity information as to a region of interest included in the reconstructed image data, based on the reconstructed image data. The processing circuitry then corrects a quantity of motion of the region of interest included in reconstructed image data containing data corresponding to at least the first energy range, based on the motion-quantity information.

### CROSS-REFERENCE TO RELATED APPLICATION

This application is based upon and claims the benefit of priority from Japanese Patent Application No. 2022-164738, filed on Oct. 13, 2022; the entire contents of which are incorporated herein by reference.

### FIELD

Embodiments described herein relate generally to an X-ray computed tomography imaging apparatus, a medical image correction method, and a nonvolatile computer-readable storage medium storing a medical image correction program.

### BACKGROUND

Traditional X-ray computed tomography (CT) imaging apparatuses perform motion correction of reconstructed medical images. In the motion correction, presence of severe calcifications and/or an excessively high degree of contrast enhancement may cause artifacts, which may hinder accurate acquisition of motion of an object to be corrected.

### BRIEF DESCRIPTION OF THE DRAWINGS

FIG. 1 illustrates a structure of a photon counting X-ray CT apparatus according to some embodiments, by way of example;

FIG. 2 illustrates a variation in pixel value of an X-ray absorber relative to pixel positions in a region of interest (ROI) with respect to multiple energy ranges according to some embodiments, by way of example;

FIG. 3 is a flowchart illustrating an exemplary image correction procedure according to some embodiments;

FIG. 4 schematically illustrates a motion of an ROI and a simplified motion of the ROI during the interval from time t− to time t0 to time t+ according to some embodiments, by way of example;

FIG. 5 schematically illustrates a simplified motion of some pixel in an ROI according to a modification of some embodiments; and

FIG. 6 illustrates four energy bins relative to energy (keV) according to an application of some embodiments, by way of example.

### DETAILED DESCRIPTION

An X-ray computed tomography imaging apparatus according to one embodiment includes processing circuitry. The processing circuitry obtains reconstructed image data corresponding to a second energy range including an energy range different from a first energy range. The processing circuitry infers motion-quantity information as to a region of interest included in the reconstructed image data, based on the reconstructed image data. The processing circuitry then corrects a quantity of motion of the region of interest included in reconstructed image data containing data corresponding to at least the first energy range, based on the motion-quantity information.

Hereinafter, embodiments of an X-ray computed tomography (CT) imaging apparatus, a medical image correction method, and a medical image correction program will be described in detail with reference to the accompanying drawings. The following embodiments will omit redundant description of parts or elements denoted by the same reference signs that perform similar processing, when appropriate. For the sake of specificity, an X-ray CT apparatus according to some embodiments will be exemplified by a photon-counting X-ray computed tomography (CT) imaging apparatus capable of performing photon counting CT imaging.

The photon counting X-ray CT apparatus uses a photon counting X-ray detector (hereinafter, photon counting detector) to count X-ray photons transmitted through a subject, to be thereby able to reconstruct X-ray CT image data with a higher S/N ratio. The X-ray CT apparatus according to some embodiments may include an integrating (current mode measuring) X-ray detector in addition to the photon counting detector. Further, the X-ray CT apparatus according to some embodiments may be able to reconstruct X-ray CT image data according to different energies. For example, the X-ray CT apparatus may be a dual-energy X-ray CT apparatus that can reconstruct X-ray CT image data of dual energy occurring from application of two different tube voltages. In this case the dual-energy X-ray CT apparatus performs various kinds of control including switching the two tube voltages to be applied to the X-ray tube.

### Embodiment

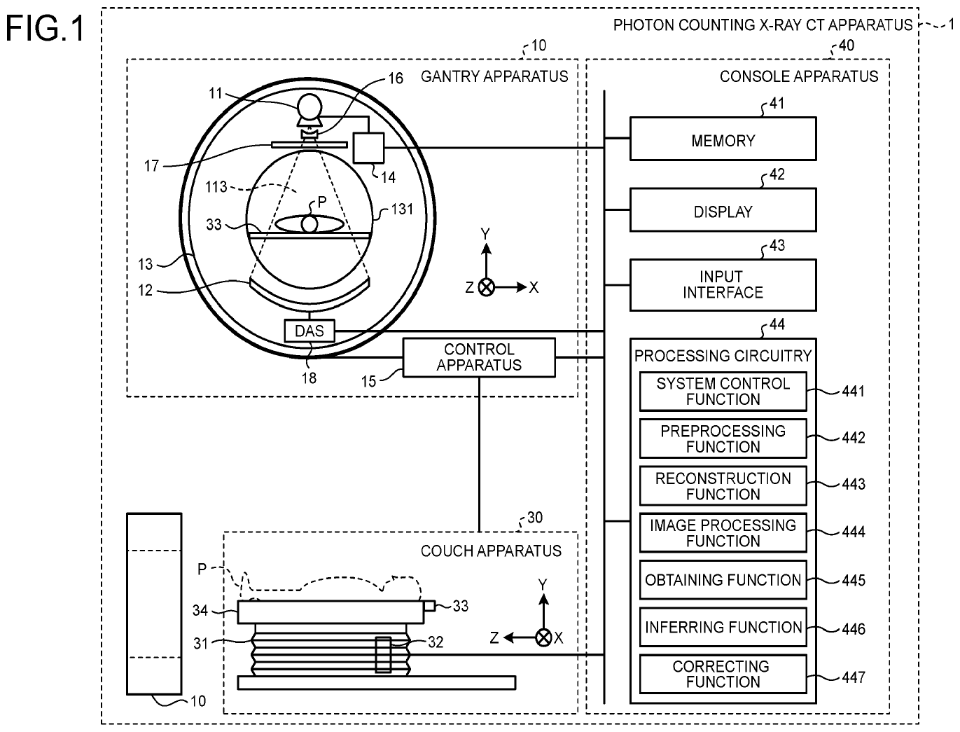

FIG. 1 illustrates a structure of a photon counting X-ray CT apparatus 1 according to some embodiments, as an example. As illustrated in FIG. 1, the photon counting X-ray CT apparatus 1 includes a gantry apparatus 10, a couch apparatus 30, and a console apparatus 40. Throughout the embodiments, the rotation axis of a rotational frame 13 in a non-tilted state or the longitudinal direction of a table top 33 of the couch apparatus 30 is defined as a Z-axis direction. An axial direction orthogonal to the Z-axis direction and horizontal to the floor is defined as an X-axis direction. An axial direction orthogonal to the Z-axis direction and vertical to the floor is defined as a Y-axis direction.

The gantry apparatus 10 and the couch apparatus 30 operate in accordance with a user's manipulation of the console apparatus 40 or of an operational unit included in the gantry apparatus 10 or the couch apparatus 30. The gantry apparatus 10, the couch apparatus 30, and the console apparatus 40 are mutually connected in a wired or wireless manner to be communicable with one another.

The gantry apparatus 10 includes an imaging system that irradiates a subject P with X-rays and detects X-rays having passed through the subject P to acquire projection data from X-ray detection data. The gantry apparatus 10 includes an X-ray tube 11 (X-ray generator), a photo counting detector 12, a rotational frame 13, an X-ray high voltage apparatus 14, a control apparatus 15, a bow-tie filter 16, a collimator 17, and a data acquisition system (DAS) 18.

The X-ray tube 11 is a vacuum tube to be applied with a high voltage and supplied with a filament current from the X-ray high-voltage apparatus 14 to generate X-rays by emitting thermoelectrons from a negative pole (filament) to a positive pole (target). The X-rays are generated as a result of collision between the thermoelectrons and the target. The X-rays are generated at the focal point of the X-ray tube 11, pass through an X-ray emission window thereof, are formed into a cone beam via the collimator 17, and emitted to the subject P. Examples of the X-ray tube 11 include a rotating anode X-ray tube that generates X-rays by emitting thermoelectrons onto a rotating positive pole.

The photon counting detector 12 counts the number of X-ray photons generated by the X-ray tube 11. For example, the photon counting detector 12 outputs pulses in accordance with the photons contained in the X-rays. Specifically, the photon counting detector 12 detects X-rays emitted from the X-ray tube 11 and having passed through the subject P on a photon basis and outputs an electric signal corresponding to an amount of the X-rays to the DAS 18. The photon counting detector 12 includes, for example, multiple arrays of detector elements arranged along a single arc about the focal point of the X-ray tube 11 in a channel direction. The photon counting detector 12 has a structure that the multiple detector element arrays are arranged in a slice direction (column or row direction), for example. The photon counting detector 12 may be referred to as a main detector that detects X-rays having penetrated through the subject P.

Specifically, the photon counting detector 12 is exemplified by an indirect-conversion detector including a grid, a scintillator array, and an optical sensor array. The scintillator array includes multiple scintillators and each scintillator includes a scintillator crystal that outputs light having a quantity of photons corresponding to an amount of incident X-rays. The grid is disposed on the X-ray incident side of the scintillator array and includes an X-ray shield plate that functions to absorb scattered X-rays. The optical sensor array includes multiple optical sensors.

Each optical sensor has a function to amplify and convert the light from the scintillators into an electric signal. The optical sensors are, for example, avalanche photo-diodes (APD) or silicon photo multipliers (SiPM). Upon the receiving light from the scintillators, the optical sensors output pulses in accordance with incident X-ray photons. The individual optical sensors thus output pulses in accordance with photons included in the X-rays. The multiple optical sensors correspond to the multiple detector elements. Namely, the photon counting detector 12 includes multiple detector elements.

The electric signal output from each of the detector elements is also referred to as a detection signal. The crest value (voltage) of the electric signal (pulse) is correlated with the energy value of X-ray photons. The photon counting detector 12 can be a direct-conversion detector including a semiconductor element that converts an incident X-ray into an electrical signal. In the case of using a direct-conversion detector as the photon counting detector 12, the electrodes of the semiconductor element correspond to the multiple detector elements.

The rotational frame 13 supports the X-ray tube 11 and the photon counting detector 12 rotatably about the rotation axis. Specifically, the rotational frame 13 is an annular frame that supports the X-ray tube 11 and the photon counting detector 12 in opposing positions to rotate the X-ray tube 11 and the photon counting detector 12 under the control of the control apparatus 15, as described later. The rotational frame 13 is supported rotatably about the rotation axis by a stationary frame (not illustrated) formed of metal such as aluminum. Specifically, the rotational frame 13 is connected to the periphery of the stationary frame via a bearing. The rotational frame 13 is supplied with power from the drive mechanism of the control apparatus 15 to rotate about the rotation axis at a constant angular rate.

The rotational frame 13 further includes and supports the X-ray high voltage apparatus 14 and the DAS 18 in addition to the X-ray tube 11 and the photon counting detector 12. The rotational frame 13 is accommodated in a substantially cylindrical housing with a bore 131 serving as an imaging space. The bore 131 substantially matches a field of view (FOV). The axis of the bore 131 matches the rotation axis of the rotational frame 13. The detection data generated by the DAS 18 is transmitted by optical communication from a transmitter with light emitting diodes (LED) included in the rotational frame 13 to a receiver with photodiodes included in the non-rotational part (e.g., the stationary frame) of the gantry apparatus 10, and then transferred to the console apparatus 40. The detection-data transmission method from the rotational frame 13 to the non-rotational part of the gantry apparatus 10 can be any method such as a non-contact or contact data transfer method, in addition to the optical communication.

The X-ray high voltage apparatus 14 includes electric circuitry such as a transformer and a rectifier, a high voltage generator, and an X-ray controller. The high voltage generator functions to generate a high voltage to be applied to the X-ray tube 11 and a filament current to be supplied to the X-ray tube 31. The X-ray controller controls the output voltage in accordance with the X-rays emitted from the X-ray tube 31. The high-voltage generator may be a transformer type or an inverter type. Further, the X-ray high-voltage apparatus 14 may be disposed in the rotational frame 13 or the stationary frame (not illustrated) of the gantry apparatus 10.

The control apparatus 15 includes processing circuitry having a central processing unit (CPU) and a driving mechanism such as a motor and an actuator. The processing circuitry includes hardware resources such as a processor as a CPU or a micro-processing unit (MPU) and memory as read only memory (ROM) and random access memory (RAM). The control apparatus 15 may be implemented by, for example, an application specific integrated circuit (ASIC), a field programmable gate array (FPGA), a complex programmable logic device (CPLD), or a simple programmable logic device (SPLD). The control apparatus 15 controls the X-ray high voltage apparatus 14 and the DAS 8 in accordance with instructions from the console apparatus 40. The control apparatus 15 retrieves and executes computer programs from the memory to implement such control.

The control apparatus 15 functions to control the operation of the gantry apparatus 10 and the couch apparatus 30, in response to receipt of input signals from an input interface attached to the console apparatus 40 or the gantry apparatus 10. For example, upon receiving input signals, the control apparatus 15 controls the rotation of the rotational frame 13, the tilting of the gantry apparatus 10, and the operation of the couch apparatus 30 and the table top 33. The control apparatus 15 may perform the tilt control over the gantry apparatus 10 by rotating the rotational frame 13 about the axis parallel to the X-axis direction according to tilt-angle information input through the input interface attached to the gantry apparatus 10.

The control apparatus 15 may be included in the gantry apparatus 10 or in the console apparatus 40. The control apparatus 15 may not store the computer programs in the memory. Instead, the computer programs may be directly embedded in the circuitry of the processor. In such a case the processor retrieves and executes the computer programs from the circuitry to implement the above control.

The bow-tie filter 16 is disposed on the front side of the X-ray emission window of the X-ray tube 11. The bow-tie filter 16 serves to adjust the amount of X-rays emitted from the X-ray tube 11. Specifically, the bow-tie filter 16 allows the X-rays emitted from the X-ray tube 11 to pass therethrough for attenuation, so that the subject P is irradiated with the X-rays from the X-ray tube 11 in a predefined distribution. The bow-tie filter 16 is formed of aluminum and has a predetermined target angle and a predetermined thickness.

The collimator 17 includes lead plates forming slits in combination to converge the X-rays having passed through the bow-tie filter 16 in an X-ray irradiation range 113.

The DAS 18 includes, for example, multiple counting circuits corresponding to the multiple detector elements. Each of the counting circuits includes, for example, a comparator and a counter. The comparator compares each detection signal output from the detector elements with two or more thresholds. The detection signal may be amplified by an amplifier disposed in a stage preceding the comparator. The comparator is connected to threshold output circuitry that outputs two or more threshold signals. The two or more threshold signals correspond to the two or more thresholds for use in discriminating multiple energy bins. The multiple energy bins correspond to multiple energy ranges. The comparator compares the detection signal and the thresholds to output a signal corresponding to the crest value of the detection signal to the console apparatus 40. The comparator may be referred to as a pulse-amplitude discriminator. Any of existing techniques is applicable to the processing of the comparator, therefore, a description thereof is omitted.

Each of the counters performs counting based on an output from the corresponding comparator. For example, the counter counts the number of photons based on the detection signal of the photon counting detector 12. Thereby, the counter generates detection data as a result of photon counting. The detection data is assigned with the number of X-ray photons per energy bin. For example, the DAS 18 counts photons (X-ray photons) of the X-rays emitted from the X-ray tube 11 and transmitted through the subject P, and discriminates the energies of the counted photons to obtain a result of the counting. The individual counters can be implemented by, for example, hardware as counting circuitry.

The detection data generated by the DAS 18 is transferred to the console apparatus 40. The detection data can be, for example, a dataset representing a pixel channel number and a column number of the detector having generated the detection signal based on temporal information, a view number (corresponding to the number representing the rotation angle of the X-ray tube 11, e.g., 1 to 1,000) of an acquired view (also referred to as projection angle), and the number of photons per energy (count of photons). The channel number, column number, and view number represent positional information as to the detector element having detected the photons. The individual counting circuits included in the DAS 18 can be, for example, implemented by a circuit group incorporating circuit elements capable of generating the detection data.

The couch apparatus 30 is an apparatus on which the subject P to be scanned is laid and moved, and includes a base 31, a couch driver 32, the table top 33, and a table-top support frame 34. The base 31 is a housing for supporting the table-top support frame 34 movably in a vertical direction. The couch driver 32 is a motor or an actuator that moves the table top 33 on which the subject P is lying in the longitudinal direction of the table top 33. The couch driver 32 moves the table top 33 under the control of the console apparatus 40 or the control apparatus 15. The table top 33 is placed on the upper side of the table-top support frame 34 and is a plate on which the subject P is to be laid. The couch driver 32 may move the table-top support frame 34 in the longitudinal direction of the table top 33 in addition to the table top 33.

The console apparatus 40 includes a memory 41, a display 42, an input interface 43, and processing circuitry 44. The memory 41, the display 42, the input interface 43, and the processing circuitry 44 perform data communications with one another via a bus (data bus).

The memory 41 is a storage that stores various kinds of information, such as a hard disk drive (HDD), a solid state drive (SSD), or an integrated circuit storage. The memory 41 stores therein, for example, projection data and reconstructed image data. Other than an HDD or SDD, the memory 41 can be a portable storage medium such as a compact disc (CD), a digital versatile disc (DVD), or a flash memory, or a driver that reads and writes various kinds of information from and to a semiconductor memory device as a random access memory (RAM). The storage regions of the memory 41 may be included in the photon counting X-ray CT apparatus 1 or in an external storage connected via a network.

The memory 41 further stores various kinds of computer programs according to the present embodiment. For example, the memory 41 stores computer programs for causing the processing circuitry 44 to implement a system control function 441, a preprocessing function 442, a reconstruction function 443, an image processing function 444, an obtaining function 445, an inferring function 446, and a correcting function 447. The memory 41 further stores therein thresholds for region identification. The memory 41 corresponds to a storage unit.

The display 42 displays various kinds of information. For example, the display 42 outputs medical images (CT images) generated by the processing circuitry 44 and a graphical user interface (GUI) that receives various kinds of user operation. Further, the display 42 displays a settings screen for allowing setting of an imaging condition with respect to the subject P, for example. The display 42 corresponds to a display unit.

Examples of the display 42 include a liquid crystal display (LCD), a cathode ray tube (CRT) display, an organic electroluminescence display (OELD), a plasma display, and any other display. The display 42 may be provided in the gantry apparatus 10. The display 42 may be a desktop type or may include a tablet terminal wirelessly communicable with the console apparatus body 40.

The input interface 43 receive various inputs from the user to convert the inputs into electrical signals and output the electrical signals to the processing circuitry 44. As an example, the input interface 43 receives, from the user, an acquisition condition for acquiring projection data, a reconstruction condition for reconstructing CT images, an image processing condition for generating post-processed images from CT images, and else. Examples of the input interface 43 include a mouse, a keyboard, a trackball, a switch, a button, a joystick, a touch-pad, and a touch panel display, as appropriate.

In the present embodiment, the input interface 43 is not limited to the one including physical operational component or components as a mouse, a keyboard, a trackball, a switch, a button, a joystick, a touch-pad, and a touch panel display. Other examples of the input interface 43 include electrical-signal processing circuitry that receives an electrical signal corresponding to an input from an external input device separated from the apparatus to output the electrical signal to the processing circuitry 44. The input interface 43 is an exemplary input unit. Alternatively, the input interface 43 may be provided in the gantry apparatus 10. The input interface 43 may include a tablet terminal wirelessly communicable with the console apparatus body 40. The input interface 43 corresponds to an input unit.

The processing circuitry 44 controls the operation of the photon counting X-ray CT apparatus 1 as a whole in accordance with electrical signals corresponding to the inputs, as output from the input interface 43. For example, the processing circuitry 44 includes hardware resources, i.e., a processor such as a CPU, a MPU, or a graphics processing unit (GPU) and memory such as a ROM or a RAM. The processing circuitry 44 uses the processor to load and execute the computer programs into the memory, to perform the processing related to the system control function 441, the preprocessing function 442, the reconstruction function 443, the image processing function 444, the obtaining function 445, the inferring function 446, and the correcting function 447. The processing circuitry 44 corresponds to a processing unit.

The processing circuitry 44 that implements the system control function 441, the preprocessing function 442, the reconstruction function 443, the image processing function 444, the obtaining function 445, the inferring function 446, and the correcting function 447 corresponds to a system control unit, a preprocessing unit, a reconstruction unit, an image processing unit, an obtaining unit, an inferrer unit, and a corrector unit, respectively. The respective functions 441 to 447 may not be implemented by a single piece of processing circuitry. The processing circuitry 44 may be constituted of a combination of multiple independent processors so that the individual processors execute the computer programs to implement the respective functions 441 to 447.

The processing circuitry 44 uses the system control function 441 to control the respective functions of the processing circuitry 44 in response to user inputs received via the input interface 43. Specifically, the system control function 441 retrieves and loads a control program from the memory 41 into the memory of the processing circuitry 44 to control the respective elements of the photon counting X-ray CT apparatus 1 according to the control program. For example, the system control function 441 controls the respective functions of the processing circuitry 44 in accordance with user inputs received via the input interface 43.

The processing circuitry 44 uses the preprocessing function 442 to subject the detection data output from the DAS 18 to preprocessing including logarithm conversion, offset correction, sensitivity correction among the channels, and beam hardening correction, to generate data. As an example, data before pre-processed will be referred to as projection data, and pre-processed data will be referred to as raw data.

The processing circuitry 44 uses the reconstruction function 443 to perform reconstruction processing to the raw data generated by the preprocessing function 442 by filtered back projection (FBP) or iterative reconstruction to generate CT image data. The reconstruction function 443 stores the reconstructed CT image data in the memory 41. The raw data generated based on a result of the counting by photo counting CT imaging contains information on the X-ray energy attenuated while transmitting through the subject P. Because of this, the reconstruction function 443 can reconstruct, for example, X-ray CT image data of particular energy components corresponding to the respective energy bins. For example, the reconstruction function 443 can reconstruct energy-bin images (also referred to as energy-band images) corresponding to the respective energy bins. For another example, the reconstruction function 443 can reconstruct X-ray CT image data (also referred to as volume data) of each of the energy components. Any of existing techniques is applicable to the reconstruction processing implemented by the reconstruction function 443, therefore, a description thereof omitted herein.

The processing circuitry 44 uses the image processing function 444 to perform various kinds of image processing to the reconstructed X-ray CT image data (volume data) in accordance with a user instruction given via the input interface 43, for example. For example, the image processing function 444 generates multiple reconstructed images of the respective energy components based on the volume data of the energy components.

The processing circuitry 44 uses the obtaining function 445 to obtain reconstructed image data corresponding to a second energy range. The second energy range includes an energy range different from a first energy range. For example, the obtaining function 445 obtains reconstructed image data from the reconstruction function 443. In the image correction process (described below) of the present embodiment implemented by a medical image processing apparatus, for example, the obtaining function 445 obtains reconstructed image data from any of various kinds of servers such as an medical image storage (e.g., picture archiving and communication system (PACS)).

The first energy range (also referred to as a first energy bin) and the second energy range (also referred to as a second energy bin) are two of different energy ranges (energy bins). The first energy range is, for example, a lower energy range than the second energy range. The reconstructed image data described above corresponds to the second energy range and may be thus referred to as second reconstructed image data. In the case of using a dual-energy X-ray CT apparatus as the X-ray CT apparatus in some embodiments, the second energy range includes a part of the first energy range. The different energy range from the first energy range is, for example, a higher energy range than the first energy range.

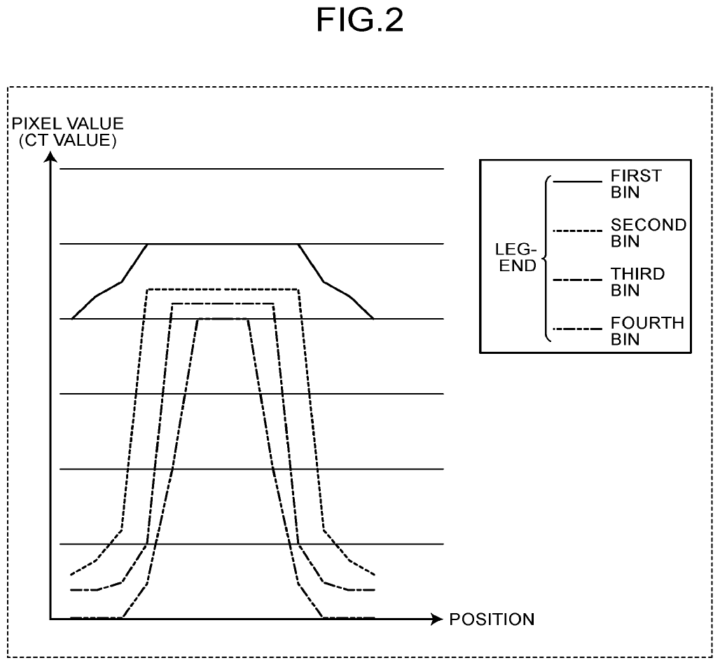

FIG. 2 illustrates a variation in pixel value (CT value) relative to pixel positions of an X-ray absorber in a region of interest (ROI) regarding the multiple energy ranges (multiple energy bins, e.g., first to fourth bins), as an example. The ROI can be set, for example, on the reconstructed image (e.g., a display image of reconstructed image data) displayed on the display 42 in accordance with a user instruction given via the input interface 43. Alternatively, the ROI may be set based on an examination order and/or a scanning condition. Thus, the ROI may be automatically set using any known automatic detecting function with respect to reconstructed images. In this case the ROI can be set in accordance with a region to be imaged specified in the examination order and/or the scanning condition. In other words, the ROI may be set by the user or automatically. The ROI may be, for example, a region including an X-ray absorber. The X-ray absorber corresponds to substances with lower X-ray transmissivity than substances with higher X-ray transmissivity (for example, air, fat, and water) inside the subject P. Specifically, the X-ray absorber can be metal, calcium, and/or a contrast agent, for example.

The energy magnitude relationship among the energy ranges (first to fourth bins) is such that the first bin<the second bin<the third bin<the fourth bin. As illustrated in FIG. 2, an object shape (profile) corresponding to the first bin contains a large amount of artifacts and thus blurs. Meanwhile, an object shape (profile) corresponding to the fourth bin contains less artifacts and is thus accurately represented. Namely, it can be said that among the four energy ranges, the higher the energy range is, the more accurately represented the object (absorber) shape is, as shown in FIG. 2.

The processing circuitry 44 uses the inferring function 446 to use reconstructed image data to infer motion-quantity information as to the ROI included in the reconstructed image data. The motion-quantity information represents, for example, a quantity of motion of the ROI on the reconstructed image data or a correction amount for a motion compensation for the ROI. The inferring function 446 infers the quantity of motion of the ROI on the reconstructed image data through various kinds of known processing, which are related to, for example, a motion artifact correcting algorithm. Various kinds of processing related to the quantity of motion inference are known, therefore, a description thereof is omitted herein.

The second energy range associated with the motion-quantity information as to the ROI can be set depending on the substance (i.e., absorber type) to be corrected in the ROI, for example, in accordance with a user instruction given via the input interface 43. As an example, the fourth bin is set as the second energy range in FIG. 2. The inferring function 446 captures a moving part of the ROI and a quantity of the motion thereof using the fourth bin. Namely, the inferring function 446 captures a region to be motion-corrected using an energy band of an accurate shape (e.g., a highest energy band as the fourth bin in FIG. 2) for the inference of a quantity of motion. Alternatively, the inferring function 446 may capture a region to be motion-corrected using other energy bands (e.g., the second to fourth bins in FIG. 2) except for the band of an inaccurate shape (e.g., a lowest energy band as the first bin in FIG. 2).

The processing circuitry 44 uses the correcting function 447 to correct, based on the inferred motion-quantity information, the quantity of motion of the ROI on reconstructed image data containing data on at least the first energy range. For example, based on the motion-quantity information representing a quantity of motion of the ROI, the correcting function 447 calculates a correction amount for adjusting the quantity of motion, to correct the quantity of motion of the ROI using the resultant correction amount. Based on the motion-quantity information representing a correction amount for motion of the ROI, the correcting function 447 corrects the quantity of motion of the ROI using an inferred correction amount.

For example, the correcting function 447 corrects reconstructed image data corresponding to the first energy range as a target. For another example, the correcting function 447 may correct first reconstructed image data corresponding to the first energy range and second reconstructed image data corresponding to the second energy range as a target. Namely, the inferring function 446 performs a motion detection on reconstructed image data of a particular energy band while the correcting function 447 corrects reconstructed image data of a different energy band from the particular energy band. The reconstructed image data to be corrected is generated in advance by the reconstruction function 443.

The processing circuitry 44 uses the correcting function 447 to correct an energy integration image based on the first energy range and the second energy range as a target. The energy integration image corresponds to, for example, an integrated image based on an integration of count data per energy in multiple energy bins. In the case of using a dual-energy X-ray CT apparatus as the X-ray CT apparatus according to some embodiments, the multiple energy bins correspond to the first energy range and the second energy range.

The energy integration image may be referred to as an energy-integrating detector (EID) image. The EID image refers to an image having CT values corresponding to pixel values. The EID image is generated by, for example, the reconstruction function 443's reconstructing count data accumulated in the multiple energy ranges (energy bins). For another example, the EID image may be generated by the image processing function 444's combining and normalizing multiple energy-bin images (energy-band images) corresponding to the multiple energy ranges (energy bins).

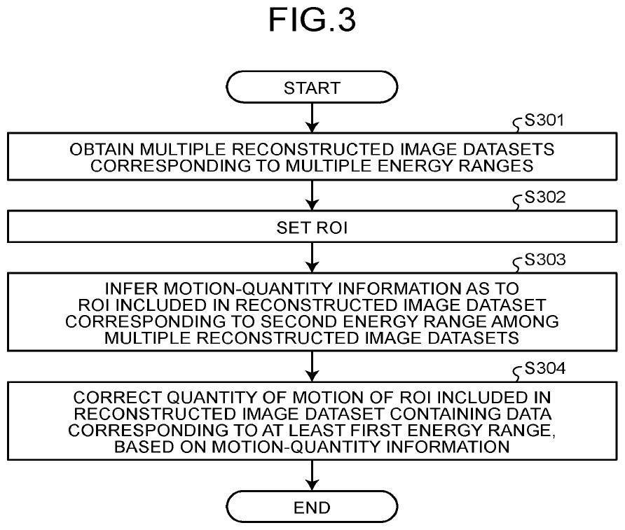

The structure and configuration of the photon counting X-ray CT apparatus 1 according to some embodiments have been described above, as an example. In the following, an exemplary image correction procedure to be performed by the photon counting X-ray CT apparatus 1 will be described with reference to FIG. 3. The image correction refers to, for example, a process of correcting a moving state (quantity of motion) of a region of interest. The image correction process in some embodiments may also be referred to as a motion (moving state) correction process.

FIG. 3 is a flowchart illustrating an image correction procedure by way of example. For the sake of specificity, the number of energy bins (energy ranges) is defined as four herein. In addition, assumed that prior to a start of the image correction process, the control apparatus 15 has scanned the subject P in the four energy ranges, and the reconstruction function 443 has generated reconstructed image datasets corresponding to the respective energy ranges.

### Image Correction Process

### Step S301

The processing circuitry 44 uses the obtaining function 445 to obtain multiple reconstructed image datasets corresponding to the multiple energy ranges. If incorporated in a medical image processing apparatus, the obtaining function 445 obtains multiple reconstructed image datasets generated by the photon counting X-ray CT apparatus from the photon counting X-ray CT apparatus. Alternatively, the obtaining function 445 included in a medical image processing apparatus obtains multiple reconstructed image datasets of the respective energy ranges from a medical image storage.

### Step S302

The processing circuitry 44 displays at least one of the reconstructed image datasets on the display 42. The image displayed on the display 42 may be an energy integration image. In this case, the obtaining function 445 obtains an energy integration image prior to step S302. A ROI is set on the displayed image by a user instruction given via the input interface 43. The ROI setting may be automatically performed according to an examination order and/or a scanning condition, in place of a user instruction.

### Step S303

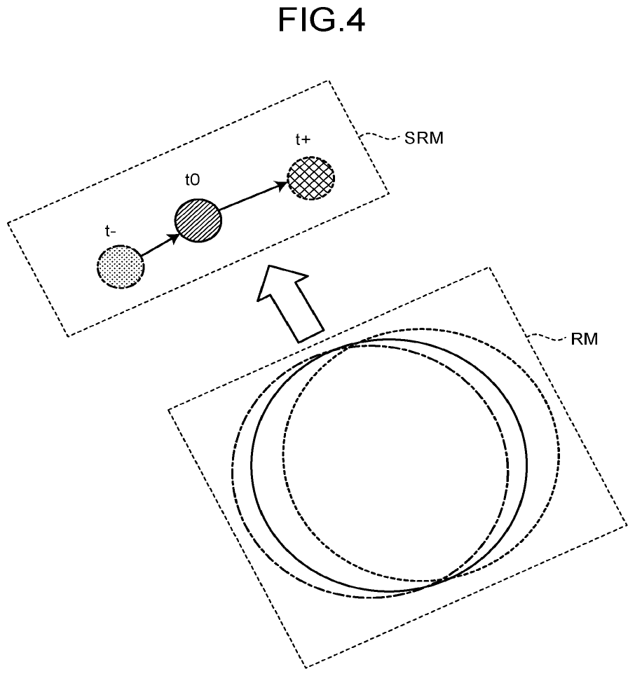

The processing circuitry 44 uses the inferring function 446 to infer motion-quantity information as to the ROI included in a reconstructed image dataset of a higher energy range (second energy range) among the multiple reconstructed image datasets. The ROI motion-quantity information will be explained below with reference to FIG. 4.

FIG. 4 illustrates a motion RM of the ROI and a simplified motion SRM thereof in a time interval from time t− to t0 to t+, by way of example. As illustrated in FIG. 4, the ROI is defined to move from left to right in the interval from time t− to t+. ROI motion-quantity information representing the quantity of motion of the ROI corresponds to the arrows (vectors) in the simplified motion SRM of the ROI, as shown in FIG. 4. ROI motion-quantity information representing a correction amount for a motion compensation for the ROI corresponds to arrows (vectors) reverse to the arrows in the simplified motion SRM of the ROI.

### Step S304

The processing circuitry 44 uses the correcting function 447 to correct the quantity of motion of the ROI included in the reconstructed image dataset concerned based on the motion-quantity information. Based on the ROI motion-quantity information representing the quantity of motion of the ROI, the correcting function 447 calculates a correction amount for a motion compensation for the ROI. The correcting function 447 then corrects the quantity of motion of the ROI included in the reconstructed image dataset concerned, using the correction amount for a motion compensation for the ROI. Through such a procedure, the image correction process to the reconstructed image data of interest completes.

The X-ray CT apparatus of some embodiments described above obtains reconstructed image data corresponding to the second energy range. The second energy range includes an energy range different from the first energy range. The X-ray CT apparatus infers, based on the reconstructed image data, motion-quantity information as to an ROI included in the reconstructed image data to correct a quantity of motion of the ROI included in reconstructed image data containing data corresponding to at least the first energy range, based on the motion-quantity information. In the X-ray CT apparatus of the present embodiment, the second energy range includes a part of the first energy range, and the energy range different from the first energy range is a higher energy range than the first energy range. Alternatively, in the X-ray CT apparatus of the present embodiment the first energy range and the second energy range may be two of the multiple energy ranges, and the first energy range may be a lower energy range than the second energy range.

In the X-ray CT apparatus of the present embodiment, the ROI is set to a region including an X-ray absorber. In the X-ray CT apparatus of the present embodiment, the X-ray absorber is metal, calcium, and/or a contrast agent. In the X-ray CT apparatus of the present embodiment, the motion-quantity information represents the quantity of motion of the ROI or a correction amount for a motion compensation for the ROI.

The X-ray CT apparatus of the present embodiment corrects reconstructed image data corresponding to the first energy range as a target. In addition, the X-ray CT apparatus of the present embodiment may correct first reconstructed image data corresponding to the first energy range and second reconstructed image data corresponding to the first energy range as a target. The X-ray CT apparatus of the present embodiment may correct an energy integration image based on the first energy range and the first energy range as a target.

Owing to such features, the X-ray CT apparatus of the present embodiment can infer the motion-quantity information (quantity of ROI motion or correction amount for ROI motion) as to the ROI including an X-ray absorber region, based on reconstructed image data of the energy range that allows capture of an accurate shape of the X-ray absorber, i.e., the energy range other than the one which may result in capturing an inaccurate shape of the X-ray absorber, as illustrated in FIG. 2. Thus, the X-ray CT apparatus can correct, based on the motion-quantity information as to the ROI, the quantity of motion of the ROI appearing on the reconstructed image data corresponding to the energy range different from the one used in the inference.

As such, the X-ray CT apparatus of the present embodiment can be simplified in terms of procedure and processing details of the inference of the ROI motion-quantity information, leading to reducing computational costs and implementing a higher-speed image correction process. Further, the X-ray CT apparatus of the present embodiment can capture an accurate shape of the X-ray absorber in the ROI, thereby improving the inference of the ROI motion-quantity information in accuracy.

Thus, irrespective of occurrence of artifacts due to the X-ray absorber, more accurate motion correction is feasible in a shorter period of time. In other words, the X-ray CT apparatus of the present embodiment can more accurately perform the image correction process at appropriate accuracy and precision in a shorter period at the time of radiogram interpretation, for example. Consequently, the X-ray CT apparatus of the present embodiment can improve the throughput related to the examination of the subject P, that is, the examination efficiency with respect to the subject P.

### Modification

An exemplary modification is now presented. This modification is such that the correcting function 447 may not use the motion-quantity information as to the ROI in correcting the ROI motion, depending on the state of the motion-quantity information. Specifically, when the quantity of motion of each pixel or the correction amount for each pixel in the ROI exceeds a preset amount, the correcting function 447 corrects the quantity of motion of the ROI without using the quantity of motion or the correction amount exceeding the preset amount.

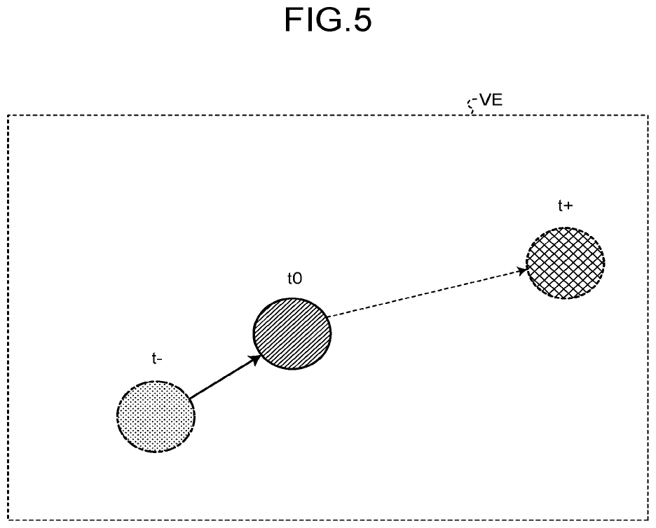

FIG. 5 illustrates an example of a simplified motion VE of one pixel in the ROI. In the interval between time t0 and time t+, the ROI moves a longer distance (hereinafter, a larger quantity of motion) in the simplified motion VE of FIG. 5 than in the simplified motion SRM of FIG. 4. If the larger quantity of motion of the one pixel is more than the preset amount, the correcting function 447 corrects motion of the ROI included not in the reconstructed image data at time t+but in the reconstructed image data at time to. Any of known techniques is applicable to this motion correction, therefore, a description thereof is omitted herein.

The X-ray CT apparatus of this modification can simplify the image correction procedure according to the ROI motion-quantity information to be thereby able to further improve the image correction process in speed. As a result, the X-ray CT apparatus of this modification can attain further improvement in throughput related to the examination of the subject P, i.e., examination efficiency with respect to the subject P. The rest of the effects of this modification is the same as or similar to those of the embodiments, so that a description thereof is omitted.

### Application

An exemplary application is presented. This application concerns setting or selecting at least one of the first energy range and the second energy range depending on a substance to be corrected in the ROI. In the case of using the photon counting X-ray CT apparatus 1 as the X-ray CT apparatus of some embodiments, for example, the processing circuitry 44 selectively sets, as the second energy range, from among the multiple energy ranges (energy bins), the energy range (hereinafter, capturing energy range) that allows capture of an accurate shape of an object to be motion-corrected. In addition, the processing circuitry 44 may selectively set the energy range to be corrected (hereinafter, target energy range) as the first energy range from among the multiple energy ranges (energy bins). Setting at least either of the capturing energy range and the target energy range can be implemented by, for example, a setting function (not illustrated) or the inferring function 446 of the processing circuitry 44.

At least either of the capturing energy range and the target energy range can be set, for example, prior to a scan of the subject P. Specifically, the processing circuitry 44 sets at least one of the capturing energy range and the target energy range according to an examination order and/or a scanning condition for the subject P. As an example, the processing circuitry 44 retrieves a correspondence table from the memory 41. The correspondence table lists at least one of the capturing energy range and the target energy range relative to a region to be imaged and a use or non-use of a contrast agent specified in the examination order and/or the scanning condition. The processing circuitry 44 then sets or selects at least one of the capturing energy range and the target energy range as a result of comparing between the correspondence table and the examination order and/or the scanning condition for the subject P. As an example of setting at least one of the capturing energy range and the target energy range, the capturing energy range may be determined by the highest and lowest energy values (hereinafter, energy thresholds) therein.

Further, at least one of the capturing energy range and the target energy range may be set by a user instruction given via the input interface 43. In this case, at least one of the capturing energy range and the target energy range can be set by adjusting default energy thresholds according to a user instruction.

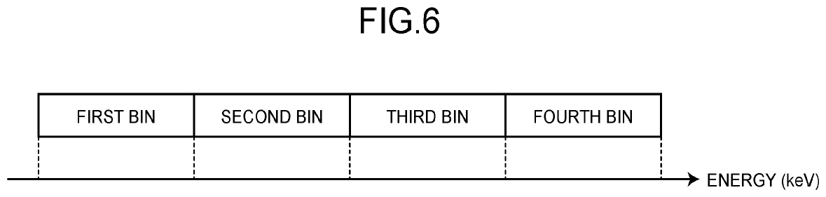

FIG. 6 illustrates four energy bins relative to energy (keV) as an example. For example, the blood vessel of the subject P into which a contrast agent is injected in the ROI is defined as a subject of motion correction. In this case, among the four energy bins in FIG. 6, the third bin is set as the second energy range (capturing energy range). The first bin and the second bin are set as the first energy range (target energy range), for example. The fourth bin may be additionally set as the first energy range (target energy range).

For another example, a metal such as a stent present in the ROI is defined as a subject of motion correction. In this case, among the four energy bins in FIG. 6, the fourth bin is set as the second energy range (capturing energy range). The first to third bins are set as the first energy range (target energy range), for example. In this application, at least one of the capturing energy range and the target energy range is set, for example, before the operation at step S301 in the image correction procedure of FIG. 3. The rest of the image correction process of this application is the same as or similar to that of the embodiments, therefore, a description thereof is omitted.

The X-ray CT apparatus of this application sets at least one of the first energy range and the second energy range depending on the substance to be corrected in the ROI. In other words, to infer the quantity of ROI motion or the correction amount, the X-ray CT apparatus of this application can set, as the capturing energy range, the energy range (energy bin) that allows easier capturing of the shape of an object to be motion-detected, depending on this object. Because of this, the X-ray CT apparatus according to this application can more accurately capture the shape of the X-ray absorber. Thus, the X-ray CT apparatus of this application can further improve the motion correction by the image correction process in accuracy and precision. The rest of the effects of this application is the same as or similar to those of the embodiments, therefore, a description thereof is omitted.

To implement the technical idea of some embodiments by a medical image processing apparatus such as a workstation (server), the medical image processing apparatus includes the elements of the console apparatus 40 shown in FIG. 1. In such a medical image processing apparatus, the processing circuitry 44 uses the obtaining function 445 to obtain, from a medical information apparatus, reconstructed image data corresponding to the second energy range including the energy range different from the first energy range. The processing circuitry 44 infers, from the reconstructed image data, motion-quantity information as to a region of interest included in the reconstructed image data, to correct, based on the motion-quantity information, a quantity of motion of the region of interest included in reconstructed image data containing data corresponding to at least the first energy range.

Examples of the medical information apparatus include a photon counting X-ray CT apparatus, a dual-energy X-ray CT apparatus, and a medical image storage (e.g., picture archiving and communication system (PACS) server). The procedure and effects of the image correction process performed by the medical image processing apparatus are the same as or similar to those of the embodiments, therefore, a description thereof is omitted.

To implement the technical idea of some embodiments by a medical image correction method, the medical image correction method includes obtaining reconstructed image data corresponding to a second energy range including an energy range different from a first energy range; inferring motion-quantity information as to a region of interest included in the reconstructed image data, based on the reconstructed image data; and correcting a quantity of motion of the region of interest included in reconstructed image data containing data corresponding to at least first energy range, based on the motion-quantity information. The procedure and effects of the image correction process performed by the medical image correction method are the same as or similar to those of the embodiments, therefore, a description thereof is omitted.

To implement the technical idea of some embodiments by a medical image correction program, the medical image correction program causes a computer to execute obtaining reconstructed image data corresponding to a second energy range including an energy range different from a first energy range; inferring motion-quantity information as to a region of interest included in the reconstructed image data, based on the reconstructed image data; and correcting a quantity of motion of the region of interest included in reconstructed image data containing data corresponding to at least first energy range, based on the motion-quantity information.

For example, the medical image correction program may be installed and loaded into the memory in the computer of a server (processing apparatus) connected to the photon counting X-ray CT apparatus or the dual-energy X-ray CT apparatus, to be able to implement the image correction process. The medical image correction program that causes the computer to execute the image correction process may be stored and distributed in a storage medium such as a magnetic disk (e.g., hard disk), an optical disk (e.g., CD-ROM, DVD), or a semiconductor memory. The procedure and effects of the medical image correction program are the same as or similar to those of the embodiments, therefore, a description thereof is omitted.

According to at least one of the embodiments described above, time-saving, more accurate motion correction can be implemented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray computed tomography imaging apparatus comprising:
processing circuitry configured to:
obtain reconstructed image data corresponding to a second energy range, the second energy range including an energy range different from a first energy range;
infer motion-quantity information as to a region of interest included in the reconstructed image data, based on the reconstructed image data; and
correct a quantity of motion of the region of interest included in reconstructed image data containing data corresponding to at least the first energy range, based on the motion-quantity information.

2. The X-ray computed tomography imaging apparatus according to claim 1, wherein
the first energy range and the second energy range are two of a plurality of energy ranges, and
the first energy range is a lower energy range than the second energy range.

3. The X-ray computed tomography imaging apparatus according to claim 1, wherein
the second energy range includes a part of the first energy range, and
the energy range different from the first energy range is a higher energy range than the first energy range.

4. The X-ray computed tomography imaging apparatus according to claim 1, wherein
the region of interest is a region including an X-ray absorber.

5. The X-ray computed tomography imaging apparatus according to claim 4, wherein
the X-ray absorber includes metal, calcium, and/or a contrast agent.

6. The X-ray computed tomography imaging apparatus according to claim 1, wherein
the motion-quantity information represents the quantity of motion of the region of interest or a correction amount for a motion compensation for the region of interest.

7. The X-ray computed tomography imaging apparatus according to claim 1, wherein
the processing circuitry is further configured to correct reconstructed image data corresponding to the first energy range as a target.

8. The X-ray computed tomography imaging apparatus according to claim 1, wherein
the processing circuitry is further configured to correct first reconstructed image data corresponding to the first energy range and second reconstructed image data corresponding to the second energy range as a target.

9. The X-ray computed tomography imaging apparatus according to claim 1, wherein
the processing circuitry is further configured to correct an energy integration image based on the first energy range and the second energy range as a target.

10. The X-ray computed tomography imaging apparatus according to claim 1, wherein
at least one of the first energy range and the second energy range is set depending on a substance to be corrected in the region of interest.

11. A medical image correction method comprising:
obtaining reconstructed image data corresponding to a second energy range, the second energy range including an energy range different from a first energy range;
inferring motion-quantity information as to a region of interest included in the reconstructed image data, based on the reconstructed image data, and
correcting a quantity of motion of the region of interest included in reconstructed image data containing data corresponding to at least the first energy range, based on the motion-quantity information.

12. A nonvolatile computer-readable storage medium storing a medical image correction program which causes a computer to execute:
obtaining reconstructed image data corresponding to a second energy range, the second energy range including an energy range different from a first energy range;
inferring motion-quantity information as to a region of interest included in the reconstructed image data, based on the reconstructed image data, and
correcting a quantity of motion of the region of interest included in reconstructed image data containing data corresponding to at least the first energy range, based on the motion-quantity information.
